(19) United States
(12) Patent Application Publication
(10) Pub. No.: US 2026/0059274 A1
(43) Pub. Date: Feb. 26, 2026

(54) SENSING MEASUREMENT SETUP METHOD, ELECTRONIC DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/103,484

(22) PCT Filed: Aug. 22, 2022
(86) PCT No.: PCT/CN2022/114034

§ 371 Date: Feb. 12, 2025

(51) Int. Cl. H04W 4/38; H04W 4/70; H04W 24/10

(52) U.S. Cl. CPC H04W 4/38; H04W 4/70; H04W 24/10

(57) ABSTRACT

A method and system for sensing measurement setup and management are disclosed, enabling effective coordination between a sensing initiator and multiple sensing responders. The method involves receiving a sensing measurement setup termination request frame, obtaining a first sensing measurement setup identifier (MSID) included in the frame, and initiating or modifying sensing measurement setup with a designated first responder among multiple responders based on the MSID. The system ensures proper configuration and termination of sensing measurement processes by transmitting corresponding setup or termination frames. The sensing measurement setup incorporates parameters such as sensing measurement identifiers, report parameters, and user identifiers to streamline the configuration and maintain compatibility with responders'capabilities. This solution improves the reliability and flexibility of sensing measurements in wireless networks.

### CROSS-REFERENCE TO RELATED APPLICATION

The present application is a U.S. National Stage of International Application No. PCT/CN2022/114034, filed on Aug. 22, 2022, the contents of all of which are incorporated herein by reference in their entirety for all purposes.

### BACKGROUND OF THE INVENTION

With the rapid development of mobile communication technology, wireless fidelity (Wi-Fi) technology has made great progress in terms of transmission rate as well as throughput. Currently, research on the Wi-Fi technology includes 320 MHz bandwidth transmission, aggregation and cooperation of a plurality of frequency bands, and so on. The application scenarios of the Wi-Fi technology include video transmission, augmented reality (AR), and virtual reality (VR), and so on.

The aggregation and cooperation of a plurality of frequency bands refers to simultaneous communication between devices in 2.4 GHz, 5.8 GHz, 6 GHz and other frequency bands. For the scenario of simultaneous communication between devices in a plurality of frequency bands, a new media access control (MAC) mechanism needs to be defined for management. Further, the aggregation and cooperation of a plurality of frequency bands is expected to be able to support low-latency transmission.

Currently, a maximum bandwidth to be supported in the aggregation and cooperation technology of a plurality of frequency bands is 320 MHz (160 MHz+160 MHz). In addition, 240 MHz (160 MHz+80 MHz) and other bandwidths supported by existing standards may also be supported possibly.

In the current Wi-Fi technology in research, a wireless local area network (WLAN) sensing technology may be supported, such as location discovery, proximity detection, and presence detection in dense environments (such as home environment and corporate environment).

### SUMMARY OF THE INVENTION

Embodiments of the present disclosure relate to the field of mobile communication, and in particular to a sensing measurement setup method, an electronic device, and a storage medium.

In one aspect, the embodiments of the present disclosure provide a sensing measurement setup method. The method is performed by a sensing initiator, and includes: receiving a sensing measurement setup termination request frame, and obtaining a first sensing measurement setup identifier (MSID) included in the sensing measurement setup termination request frame; and setting up, in a case that the first MSID corresponds to at least two sensing responders, sensing measurement with a first responder in the sensing responders, where the sensing responders include the first responder and a second responder, and the second responder is a sensing responder that transmits the sensing measurement setup termination request frame.

In another aspect, the embodiments of the present disclosure further provide a sensing measurement setup method, performed by a sensing responder. The sensing responder is a first responder. The method includes: receiving a sensing measurement setup request frame transmitted by a sensing initiator, where the sensing measurement setup request frame is transmitted by the sensing initiator in a case that the sensing initiator receives a sensing measurement setup termination request frame transmitted by a second responder and determines that a first sensing measurement setup identifier (MSID) included in the sensing measurement setup termination request frame corresponds to at least two sensing responders, and the sensing responders include the first responder and the second responder; and setting up sensing measurement with the sensing initiator in response to the sensing measurement setup request frame.

In yet another aspect, the embodiments of the present disclosure further provide an electronic device. The electronic device is a sensing initiator. The electronic device includes: a reception module configured to receive a sensing measurement setup termination request frame, and obtain a first sensing measurement setup identifier (MSID) included in the sensing measurement setup termination request frame; and a setup module configured to set up, in a case that the first MSID corresponds to at least two sensing responders, sensing measurement with a first responder in the sensing responders, where the sensing responders include the first responder and a second responder, and the second responder is a sensing responder that transmits the sensing measurement setup termination request frame.

In yet another aspect, the embodiments of the present disclosure further provide an electronic device. The electronic device is a sensing responder. The sensing responder is a first responder. The electronic device includes: a request receiving module configured to receive a sensing measurement setup request frame transmitted by a sensing initiator, where the sensing measurement setup request frame is transmitted by the sensing initiator in a case that the sensing initiator receives a sensing measurement setup termination request frame transmitted by a second responder and determines that a first sensing measurement setup identifier (MSID) included in the sensing measurement setup termination request frame corresponds to at least two sensing responders, and the sensing responders include the first responder and the second responder; and an execution module configured to set up sensing measurement with the sensing initiator in response to the sensing measurement setup request frame.

The embodiments of the present disclosure further provide an electronic device. The electronic device includes a memory, a processor, and a computer program stored on the memory and runnable on the processor. The processor implements the method according to one or more embodiments of the present disclosure when executing the program.

The embodiments of the present disclosure further provide a non-transitory computer-readable storage medium, storing a computer program. The computer program implements the method according to one or more embodiments of the present disclosure when executed by a processor.

### BRIEF DESCRIPTION OF DRAWINGS

In order to describe the technical solutions in embodiments of the present disclosure more clearly, the accompanying drawings required for describing the embodiments of the present disclosure are briefly described below. The accompanying drawings in the following description are merely some embodiments of the present disclosure. Those of ordinary skill in the art can also derive other accompanying drawings from these accompanying drawings without creative efforts.

FIG. 1 is a first flowchart of a sensing measurement setup method according to an embodiment of the present disclosure.

FIG. 2 is a first schematic diagram of a first instance of an embodiment of the present disclosure.

FIG. 3 is a second schematic diagram of a first instance of an embodiment of the present disclosure.

FIG. 4 is a third schematic diagram of a first instance of an embodiment of the present disclosure.

FIG. 5 is a schematic diagram of a second instance of an embodiment of the present disclosure.

FIG. 6 is a second flowchart of a sensing measurement setup method according to an embodiment of the present disclosure.

FIG. 7 is a third flowchart of a sensing measurement setup method according to an embodiment of the present disclosure.

FIG. 8 is a first schematic structural diagram of an electronic device according to an embodiment of the present disclosure.

FIG. 9 is a second schematic structural diagram of an electronic device according to an embodiment of the present disclosure.

FIG. 10 is a third schematic structural diagram of an electronic device according to an embodiment of the present disclosure.

### DETAILED DESCRIPTION OF THE INVENTION

In the implementations of the present disclosure, the term “and/or,” which is an association relation describing an associated object, indicates that there may be three relations. For example, A and/or B may indicate three situations: A exists alone, A and B exist at the same time, and B exists alone. The character “/” generally indicates that the associated objects are in an “or” relation.

In the embodiments of the present disclosure, the term “a plurality” refers to two or more, and other quantifiers are understood similarly.

A description will be made in detail to an example here, and their instances are illustrated in the accompanying drawings. When the following description relates to the accompanying drawings, the same numbers in different accompanying drawings denote the same or similar elements, unless indicated otherwise. The implementations described in the following example do not denote all implementations consistent with the present disclosure. On the contrary, the implementations are merely instances of apparatuses and methods consistent with some aspects of the present disclosure, as recited in the appended claims.

The terms used in the present disclosure are merely to describe the specific embodiments, instead of limiting the present disclosure. The singular forms such as “a,” “an,” “the,” and “this” used in the present disclosure and the appended claims are also intended to include the plural forms unless clearly stated otherwise in the context. It should also be understood that the term “and/or” as used in the disclosure refers to and encompasses any or all possible combinations of one or more of associated items listed.

It should be understood that although the terms “first,” “second,” “third,” etc. may be employed in the present disclosure to describe various information, such information is not to be limited to these terms. These terms are merely used to distinguish the same type of information from each other. For example, first information can also be referred to as second information, and similarly, second information can also be referred to as first information, without departing from the scope of the present disclosure. Depending on the context, the word “if” as used in the disclosure can be interpreted as “at the time of,” “when,” or “in response to determining”.

The technical solutions in the embodiments of the present disclosure will be clearly and completely described below with reference to the accompanying drawings in the embodiments of the present disclosure. The described embodiments are merely some embodiments rather than all embodiments of the present disclosure. On the basis of the embodiments of the present disclosure, all other embodiments derived by those of ordinary skill in the art without creative efforts fall within the scope of protection of the present disclosure.

In a WLAN sensing measurement process (the sensing measurement process is a sensing measurement setup), a sensing responder can request a termination of the sensing measurement setup. Thus, a flow of the sensing responder to initiate a termination and a re-setup of a sensing measurement process needs to be provided to improve a WLAN measurement process.

The embodiments of the present disclosure provide a sensing measurement setup method, an electronic device, and a storage medium, so as to provide a flow of sensing responders to initiate a termination and a re-setup of a sensing measurement process.

The method and device are based on the same application concept. Since the method and device have the similar principles for solving problems, the device and method may be implemented with reference to each other, without repeated portions described in detail.

As shown in FIG. 1, the embodiments of the present disclosure provide a sensing measurement setup method. In an example, the method may be performed by a sensing initiator (for example access point (AP)). The method may include steps 101 and 102.

In step 101, a sensing measurement setup termination request frame is received, and a first sensing measurement setup identifier (MSID) included in the sensing measurement setup termination request frame is obtained.

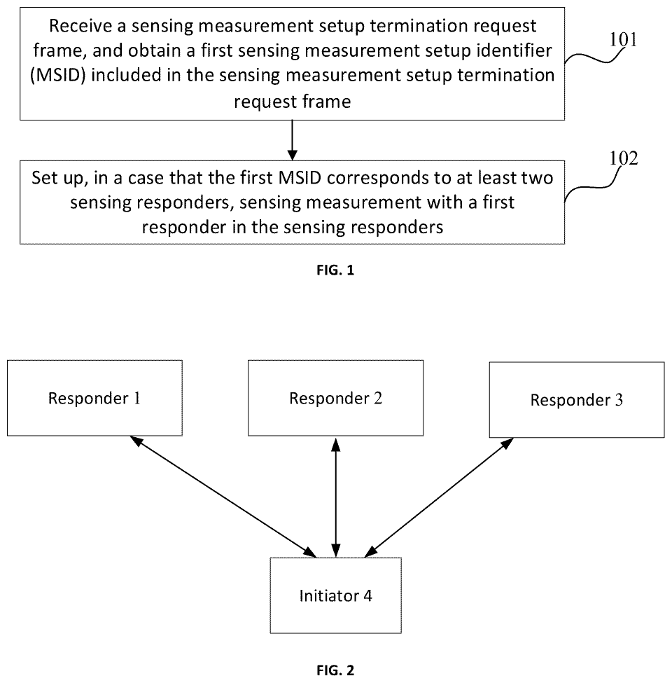

As a first instance, with reference to FIGS. 2-4, an architecture of WLAN sensing and a WLAN sensing process applied by a sensing measurement setup method provided in the embodiments of the present disclosure are first introduced.

FIG. 2 is a schematic diagram of an architecture of WLAN sensing (a process). A sensing initiator 4 (or an initiator) initiates the WLAN sensing (for example, initiates a WLAN sensing session). A plurality of sensing responders (or sensing receivers) or responders, such as responder 1, responder 2 and responder 3 shown in FIG. 2, may respond to the WLAN sensing. In a case that the sensing initiator initiates the WLAN sensing, a plurality of associated or unassociated sensing responders for the WLAN sensing may respond.

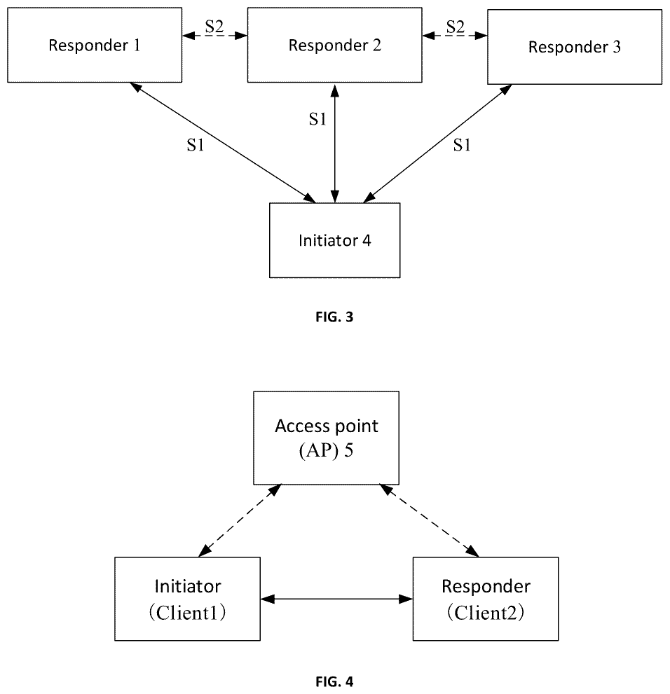

With reference to FIG. 3, the sensing initiator 4 communicates with the sensing responders 1, 2, and 3 through communication connection, for example, communication connection S1. The sensing responders 1, 2, and 3 communicate with each other through communication connection S2.

Each sensing initiator may be a client. Each sensing responder (in this instance, sensing responder 1 to sensing responder 3) may be a station (STA) or an access point (AP). Furthermore, the STA and the AP may assume a plurality of roles in the WLAN sensing process. For example, the STA may also act as a sensing initiator in the WLAN sensing process. The sensing initiator may be a sensing transmitter, a sensing receiver, both or neither. In the WLAN sensing process, the sensing responder may also be a sensing transmitter, a sensing receiver, or both.

As another architecture, as shown in FIG. 4, both the sensing initiator and the sensing responder may be clients, and may communicate with each other by being connected to a same access point (AP) 5. In FIG. 4, client 1 is the sensing initiator, and Client 2 is the sensing responder.

Generally, a WLAN sensing process includes a triggered based (TB) sounding and a non-TB sensing. In the TB sensing measurement, the AP is an initiator or a transmitter. In the non-TB sensing measurement, the STA is an initiator or a transmitter.

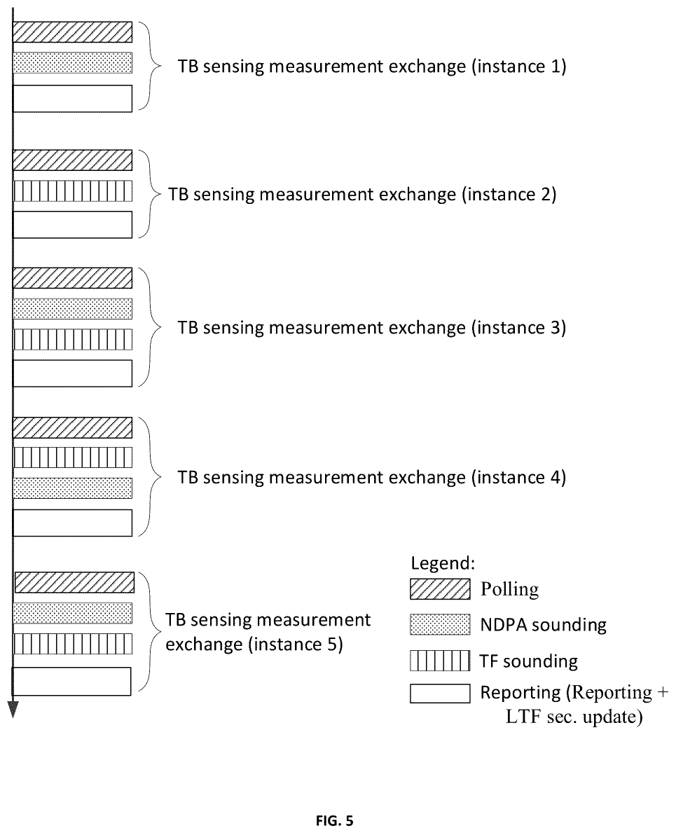

An instance of the TB sensing measurement is a sensing measurement process triggered based on trigger frames. As a second instance, the TB sensing measurement process is shown in FIG. 5. FIG. 5 shows a plurality of sensing measurement exchanges of a TB sensing measurement process. In instances 1-5, the sensing measurement process includes polling, sounding, and reporting (reporting+LTF sec. update). In each instance, the sounding may include only null data packet announcement (NDPA) sounding or trigger frame (TF) sounding, or may include both of them.

In TB sensing measurement, a sensing responder (for example, STA) may transmit a sensing measurement setup termination request frame to a sensing initiator, so as to request a termination of a sensing measurement setup. A sensing measurement setup ID (MSID) may be included in the sensing measurement setup termination request frame. After receiving the sensing measurement setup termination request frame, the sensing initiator obtains the MSID included in the sensing measurement setup termination request frame, and determines a number of sensing responders corresponding to the MSID.

In step 102, in a case that the first MSID corresponds to at least two sensing responders, sensing measurement with a first responder in the sensing responders is set up. The sensing responders include the first responder and a second responder. The second responder is a sensing responder that transmits the sensing measurement setup termination request frame.

In a case that there is one sensing responder, the sensing initiator executes a flow of sensing measurement setup termination, replies an acknowledge (ACK) frame to the sensing responder or transmits the sensing measurement setup termination request frame to the sensing responder, and releases a resource that is set up.

In a case where there are at least two sensing responders, the sensing initiator determines a second responder transmitting the sensing measurement setup termination request frame and may terminate the flow of the second responder's sensing measurement setup. For other sensing responder (the first responder) that does not transmit the sensing measurement setup termination request frame, no sensing measurement setup needs to be terminated. In a case that the sensing initiator also transmits the sensing measurement setup termination frame to the other sensing responders, negotiated network resources need to be released, which wastes signaling resources. Moreover, the sensing initiator needs to re-set up a sensing measurement setup with the other sensing responders, and network resources are also wasted. Thus in the embodiments of the present disclosure, in a case that the sensing measurement setup termination request frame transmitted by the second responder is received, the sensing measurement setup with the first sensing responder continues to be set up, such that waste of network resources due to blind initiation of a sensing measurement setup termination is avoided.

In the embodiments of the present disclosure, the sensing initiator receives the sensing measurement setup termination request frame, and obtains the first MSID included in the sensing measurement setup termination request frame; and in a case that the first MSID corresponds to at least two sensing responders, sensing measurement with the first responder that does not transmit the sensing measurement setup termination request frame is set up, such that waste of network resources due to blind initiation of a sensing measurement setup termination is avoided, and a triggered based (TB) sensing measurement mechanism is improved.

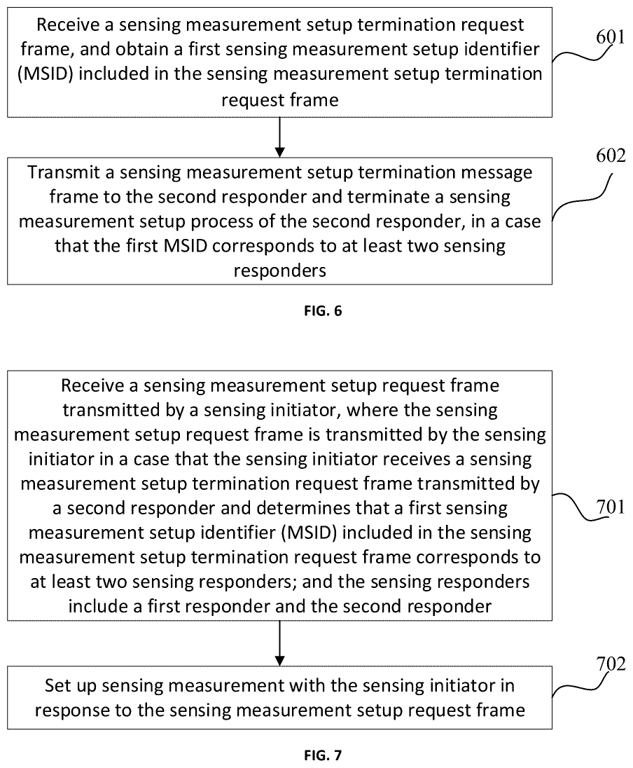

With reference to FIG. 6, the embodiments of the present disclosure provide a sensing measurement setup method. In an example, the method may be performed by a sensing initiator. The method may include steps 601 and 602.

In step 601, a sensing measurement setup termination request frame is received, and a first sensing measurement setup identifier (MSID) included in the sensing measurement setup termination request frame is obtained.

Reference is made to the first instance for the architecture of the WLAN sensing and the WLAN sensing process applied to the sensing measurement setup method provided in the embodiments of the present disclosure. Reference is made to the second instance for the TB sensing measurement process, which is not repeated.

In the TB sensing measurement, after receiving the sensing measurement setup termination request frame, the sensing initiator obtains the MSID included in the sensing measurement setup termination request frame, and determines a number of the sensing responders corresponding to the MSID.

In step 602, in a case that the first MSID corresponds to at least two sensing responders, a sensing measurement setup termination message frame is transmitted to the second responder, and a sensing measurement setup process with the second responder is terminated.

In a case that the first MSID corresponds to at least two sensing responders, for the first responder that does not transmit the sensing measurement setup termination request frame, no sensing measurement setup needs to be terminated. In a case that the sensing initiator transmits the sensing measurement setup termination frame to the first responders, negotiated network resources need to be released, which wastes signaling resources. Moreover, the sensing initiator needs to re-set up a sensing measurement setup with other sensing responders, and network resources are also wasted. Thus in the embodiments of the present disclosure, in a case that the sensing measurement setup termination request frame transmitted by the second responder is received, the sensing measurement setup with the first sensing responder continues to be set up, such that waste of network resources due to blind initiation of a sensing measurement setup termination is avoided.

The embodiments of the present disclosure provide a sensing measurement setup method. In an example, the method may be performed by a sensing initiator. The method may include:
receiving a sensing measurement setup termination request frame, and obtaining a first sensing measurement setup identifier (MSID) included in the sensing measurement setup termination request frame, where the sensing responders include a first responder and a second responder, and the second responder is a sensing responder that transmits the sensing measurement setup termination request frame; and
in a case that the first MSID corresponds to at least two sensing responders, in a process of setting up a sensing measurement setup with the first responder, still configuring for the first responder an MSID identical to the first MSID, where the first responder includes an existing STA and a newly added STA. In a case that a plurality of first sensing responders are of different sensing measurement types, such as NDPA sounding or TF sounding, the same MSID is assigned to the sensing responders.

The embodiments of the present disclosure provide a sensing measurement setup method. In an example, the method may be performed by a sensing initiator. The method may include:
receiving a sensing measurement setup termination request frame, and obtaining a first sensing measurement setup identifier (MSID) included in the sensing measurement setup termination request frame, where the sensing responders include a first responder and a second responder, and the second responder is a sensing responder that transmits the sensing measurement setup termination request frame; and
in a case that the first MSID corresponds to at least two sensing responders, transmitting a sensing measurement setup request frame to the first responder, where a sensing measurement parameter included in the sensing measurement setup request frame is identical to sensing measurement parameter of a sensing measurement process corresponding to the first MSID.

In a case that there is more than one sensing responder, the AP may set up sensing measurement with another STA (the first responder), transmits the sensing measurement setup request frame to the first responder, requests setting up the sensing measurement setup, and carries the sensing measurement parameter in the sensing measurement setup request frame. The sensing measurement parameter is consistent with the sensing measurement negotiated in the sensing measurement process corresponding to the first MSID, for example, a number of spatial streams (NSS), bandwidth (BW) and other parameters. That is, for sensing responders corresponding to a same MSID, the sensing initiator may transmit sensing measurement parameters negotiated in other sensing measurement processes corresponding to the MSID.

The embodiments of the present disclosure provide a sensing measurement setup method. In an example, the method may be performed by a sensing initiator. The method may include:
receiving a sensing measurement setup termination request frame, and obtaining a first sensing measurement setup identifier (MSID) included in the sensing measurement setup termination request frame, where the sensing responders include a first responder and a second responder, and the second responder is a sensing responder that transmits the sensing measurement setup termination request frame; and
in a case that the first MSID corresponds to at least two sensing responders and it is determined that a sensing measurement report parameter of a sensing measurement process corresponding to the first MSID is supported by the first responder, setting up sensing measurement with the first responder in the sensing responders.

The STA for the sensing measurement setup needs to support the sensing measurement report parameters (capability parameters in a sensing measurement report) negotiated by the first MSID, where the capability parameters include for example an immediate feedback capability. Both an existing STA and a newly added STA in the first sensing responder need to support the sensing measurement report parameters. The sensing initiator implements the sensing measurement setup with the STAs.

The embodiments of the present disclosure provide a sensing measurement setup method. In an example, the method may be performed by a sensing initiator. The method may include:
receiving a sensing measurement setup termination request frame, and obtaining a first sensing measurement setup identifier (MSID) included in the sensing measurement setup termination request frame, where the sensing responders include a first responder and a second responder, and the second responder is a sensing responder that transmits the sensing measurement setup termination request frame; and
in a case that the first MSID corresponds to at least two sensing responders, setting up sensing measurement with the first responder in the sensing responders; and in a case of determining that the first responder is unassociated with the sensing initiator, assigning a user ID (UID) to the first responder, that is, the UID is assigned to the STA in a sensing measurement setup process in a case that the first responder does not set up initial association with the sensing initiator.

The embodiments of the present disclosure provide a sensing measurement setup method. In an example, the method may be performed by a sensing initiator. The method may include:
receiving a sensing measurement setup termination request frame, and obtaining a first sensing measurement setup identifier (MSID) included in the sensing measurement setup termination request frame; and in a case that the first MSID corresponds to one sensing responder, transmitting a sensing measurement setup termination message frame to the sensing responder, and terminating a sensing measurement setup process of the sensing responder.

In a case that the first MSID corresponds to one sensing responder, the sensing initiator executes a flow of sensing measurement setup termination, transmits the sensing measurement setup termination request frame (or replies an acknowledge (ACK) frame) to the sensing responder, terminates the sensing measurement setup process of the sensing responder, and releases a resource that is set up.

In the embodiments of the present disclosure, the sensing initiator receives the sensing measurement setup termination request frame, and obtains the first MSID included in the sensing measurement setup termination request frame; and in a case that the first MSID corresponds to at least two sensing responders, sensing measurement with the first responder that does not transmit the sensing measurement setup termination request frame is set up, such that waste of network resources due to blind initiation of a sensing measurement setup termination is avoided, and a triggered based (TB) sensing measurement mechanism is improved.

With reference to FIG. 7, the embodiments of the present disclosure provide a sensing measurement setup method. In an example, the method may be performed by a sensing responder. The sensing responder is a first responder. The method may include steps 701 and 702.

In step 701, a sensing measurement setup request frame transmitted by a sensing initiator is received, where the sensing measurement setup request frame is transmitted by the sensing initiator in a case that the sensing initiator receives a sensing measurement setup termination request frame transmitted by a second responder and determines that a first sensing measurement setup identifier (MSID) included in the sensing measurement setup termination request frame corresponds to at least two sensing responders, and the sensing responders include a first responder and the second responder.

Reference is made to the first instance for the architecture of the WLAN sensing and the WLAN sensing process applied to the sensing measurement setup method provided in the embodiments of the present disclosure. Reference is made to the second instance for the TB sensing measurement process, which is not repeated.

In TB sensing measurement, the second responder (STA) may transmit a sensing measurement setup termination request frame to a sensing initiator, so as to request a termination of a sensing measurement setup. A sensing measurement setup ID (MSID) is included in the sensing measurement setup termination request frame. After receiving the sensing measurement setup termination request frame, the sensing initiator obtains the MSID included in the sensing measurement setup termination request frame, and determines a number of sensing responders corresponding to the MSID.

In a case that there are at least two sensing responders, for another sensing responder (the first responder) that does not transmit the sensing measurement setup termination request frame, no sensing measurement setup needs to be terminated. In a case that the sensing initiator also transmits the sensing measurement setup termination frame to other sensing responders, negotiated network resources need to be released, which wastes signaling resources. Moreover, the sensing initiator needs to re-set up a sensing measurement setup with other sensing responders, and network resources are also wasted. Thus in the embodiments of the present disclosure, in a case that the sensing measurement setup termination request frame transmitted by the second responder is received, the sensing measurement setup with the first sensing responder continues to be set up, such that waste of network resources due to blind initiation of a sensing measurement setup termination is avoided.

In step 702, sensing measurement with the sensing initiator is set up in response to the sensing measurement setup request frame.

In an example, in the embodiments of the present disclosure, a sensing measurement parameter included in the sensing measurement setup request frame is identical to sensing measurement parameter of a sensing measurement process corresponding to the first MSID.

In an example, in the embodiments of the present disclosure, an MSID configured by the sensing initiator for the first responder is identical to the first MSID.

In an example, in the embodiments of the present disclosure, a sensing measurement report parameter of a sensing measurement process corresponding to the first MSID is supported by the first responder.

In an example, in the embodiments of the present disclosure, in a case that it is determined that the first responder is unassociated with the sensing initiator, the sensing initiator assigns a user identifier (UID) to the first responder.

The embodiments of the present disclosure provide a sensing measurement setup method. In an example, the method may be performed by a sensing responder. The sensing responder is a second responder. The method may include:
transmitting a sensing measurement setup termination request frame to a sensing initiator, where a first sensing measurement setup identifier (MSID) is included in the sensing measurement setup termination request frame, and the first MSID corresponds to at least two sensing responders; and
receiving a sensing measurement setup termination message frame transmitted by the sensing initiator.

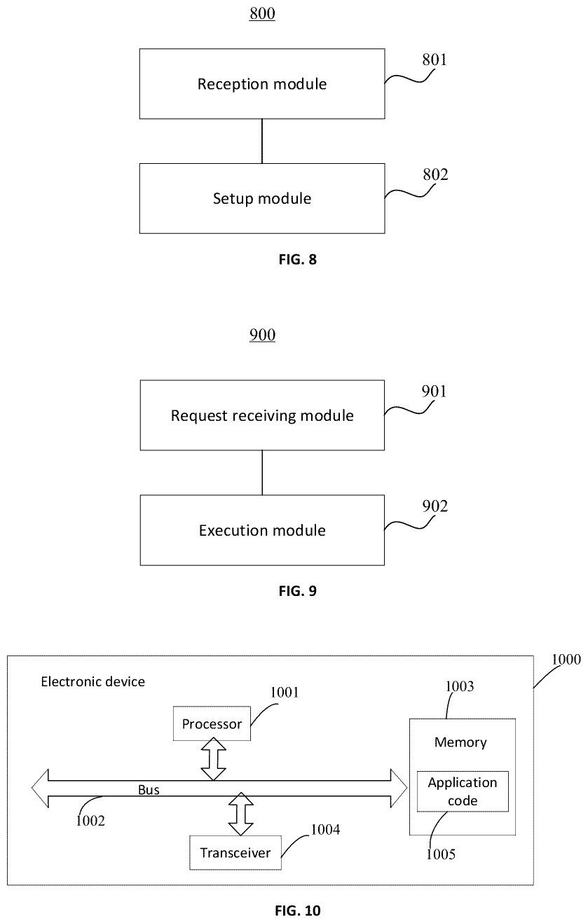

With reference to FIG. 8, based on the same principle as the method provided in the embodiments of the present disclosure, the embodiments of the present disclosure further provide an electronic device. The electronic device 800 is a sensing initiator. The electronic device 800 includes: a reception module 801 configured to receive a sensing measurement setup termination request frame, and obtain a first sensing measurement setup identifier (MSID) included in the sensing measurement setup termination request frame; and a setup module 802 configured to set up, in a case that the first MSID corresponds to at least two sensing responders, sensing measurement with a first responder in the sensing responders, where the sensing responders include the first responder and a second responder, and the second responder is a sensing responder that transmits the sensing measurement setup termination request frame.

In an example, in the embodiments of the present disclosure, the electronic device 800 further includes: a first termination module (not shown) configured to transmit a sensing measurement setup termination message frame to the second responder and terminate a sensing measurement setup process of the second responder, in a case that the first MSID corresponds to at least two sensing responders.

In an example, in the embodiments of the present disclosure, the setup module 802 includes: a transmission submodule (not shown) configured to transmit a sensing measurement setup request frame to the first responder, where a sensing measurement parameter included in the sensing measurement setup request frame is identical to sensing measurement parameter of a sensing measurement process corresponding to the first MSID.

In an example, in the embodiments of the present disclosure, the setup module 802 includes: a configuration submodule (not shown) configured to configure an MSID identical to the first MSID for the first responder.

In an example, in the embodiments of the present disclosure, the setup module 802 includes: a setup submodule (not shown) configured to determine that a sensing measurement report parameter of a sensing measurement process corresponding to the first MSID is supported by the first responder, and set up the sensing measurement with the first responder in the sensing responders.

In an example, in the embodiments of the present disclosure, the setup module 802 includes: an assignation submodule (not shown) configured to determine that the first responder is unassociated with the sensing initiator, and assign a user identifier (UID) to the first responder.

In an example, in the embodiments of the present disclosure, the electronic device 800 further includes: a first termination module (not shown) configured to transmit a sensing measurement setup termination message frame to the sensing responder and terminate a sensing measurement setup process of the sensing responder, in a case that the first MSID corresponds to one sensing responder, after the sensing measurement setup identifier (MSID) included in the sensing measurement setup termination request frame is obtained.

The embodiments of the present disclosure further provide a sensing measurement setup apparatus. The apparatus (not shown) is applied to a sensing initiator. The apparatus includes: a request frame receiving module (not shown) configured to receive a sensing measurement setup termination request frame, and obtain a first sensing measurement setup identifier (MSID) included in the sensing measurement setup termination request frame; and a measurement setup module (not shown) configured to set up, in a case that the first MSID corresponds to at least two sensing responders, sensing measurement with a first responder in the sensing responders, where the sensing responders include the first responder and a second responder, and the second responder is a sensing responder that transmits the sensing measurement setup termination request frame.

The apparatus further includes other modules of the electronic device in the foregoing embodiment, which are not repeated.

With reference to FIG. 9, based on the same principle as the method provided in the embodiments of the present disclosure, the embodiments of the present disclosure further provide an electronic device. The electronic device 900 is a sensing responder. The sensing responder is a first responder. The electronic device 900 includes: a request receiving module 901 configured to receive a sensing measurement setup request frame transmitted by a sensing initiator, where the sensing measurement setup request frame is transmitted by the sensing initiator in a case that the sensing initiator receives a sensing measurement setup termination request frame transmitted by a second responder and determines that a first sensing measurement setup identifier (MSID) included in the sensing measurement setup termination request frame corresponds to at least two sensing responders, and the sensing responders include the first responder and the second responder; and an execution module 902 configured to set up sensing measurement with the sensing initiator in response to the sensing measurement setup request frame.

The embodiments of the present disclosure further provide a sensing measurement setup apparatus. The apparatus (not shown) is applied to a sensing responder. The apparatus includes: a setup request receiving module (not shown) configured to receive a sensing measurement setup request frame transmitted by a sensing initiator, where the sensing measurement setup request frame is transmitted by the sensing initiator in a case that the sensing initiator receives a sensing measurement setup termination request frame transmitted by a second responder and determines that a first sensing measurement setup identifier (MSID) included in the sensing measurement setup termination request frame corresponds to at least two sensing responders, and the sensing responders include the first responder and the second responder; and a measurement executing module (not shown) configured to set up sensing measurement with the sensing initiator in response to the sensing measurement setup request frame.

The apparatus further includes other modules of the electronic device in the foregoing embodiment, which are not repeated.

In an embodiment, the embodiment of the present disclosure further provides an electronic device as shown in FIG. 10. The electronic device 1000 shown in FIG. 10 may be a server, and includes a processor 1001 and a memory 1003. The processor 1001 is connected to the memory 1003, for example, via a bus 1002. In an example, the electronic device 1000 may further include a transceiver 1004. It is to be noted that in practical application, the transceiver 1004 is not limited to one. A structure of the electronic device 1000 does not constitute a limitation to the embodiment of the present disclosure.

The processor 1001 may be a central processing unit (CPU), a general-purpose processor, a digital signal processor (DSP), an application specific integrated circuit (ASIC), a field programmable gate array (FPGA), or another programmable logic device, transistor logic device, hardware component, or their any combination. The processor 1001 may implement or execute various illustrative logical blocks, modules, and circuits described in connection with contents disclosed in the present disclosure. The processor 1001 may also be a combination realizing a computation function, for example, a combination encompassing one or more microprocessors, a combination of a DSP and a microprocessor, etc.

The bus 1002 may include a path to transfer information between the above components. The bus 1002 may be a peripheral component interconnect (PCI) bus, an extended industry standard architecture (EISA) bus, etc. The bus 1002 may be classified into an address bus, a data bus, a control bus, and the like. For ease of presentation, the bus 1002 is shown with only one thick line in FIG. 10, but it does not indicate that there is only one bus or one type of buses.

The memory 1003 may be a read only memory (ROM) or another type of static storage device capable of storing static information and instructions, a random access memory (RAM) or another type of dynamic storage devices capable of storing information and instructions, an electrically erasable programmable read only memory (EEPROM), a compact disc read only memory (CD-ROM) or another optical disk storage, optical disk storage (including a compact disc, a laser disc, an optical disc, a digital versatile disc, a Blue-ray disc, etc.), a magnetic disk storage medium or another magnetic storage device, or any other media that may be configured to carry or store desired program codes in a form of instructions or data structures and that may be accessed by a computer, but is not limited to this.

The memory 1003 is configured to store an application code 1005 for executing the solutions of the present disclosure, and execution is controlled by the processor 1001. The processor 1001 is configured to execute the application code 1005 stored in the memory 1003, so as to implement the content shown in the method embodiments.

The electronic device 1000 includes, but is not limited to, a mobile terminal such as a mobile phone, a notebook computer, a digital stream receiver, a personal digital assistant (PDA), a portable android device (PAD), a portable multimedia player (PMP), and an in-vehicle terminal (for example, an in-vehicle navigation terminal), and a fixed terminal such as a digital television (TV) and a desktop computer. The electronic device 1000 illustrated in FIG. 10 is merely an instance and is not to impose any limitation on the functions and scope of use of the embodiments of the present disclosure.

The server provided in the present disclosure may be an independent physical server, a server cluster or a distributed system composed of a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal may be a smart phone, a tablet computer, a notebook computer, a desktop computer, a smart slightly speaker, a smart watch, etc., but is not limited to this. The terminal and the server may be connected directly or indirectly through wired or wireless communication, which is not limited in the present disclosure.

The embodiments of the present disclosure provide a non-transitory computer-readable storage medium. The non-transitory computer-readable storage medium stores a computer program. When running on a computer, the computer program causes the computer to execute the corresponding contents in the method embodiments.

It is to be understood that while all the steps in the flowcharts of the accompanying drawings are shown sequentially as indicated by arrows, the steps are not necessarily executed sequentially in an order indicated by the arrows. Unless explicitly stated in the disclosure, an execution order of these steps is no strictly limited, and these steps can be executed in other orders. Moreover, at least some of the steps in the flowcharts of the accompanying drawings can include a plurality of sub-steps or stages. These sub-steps or stages are not necessarily executed at the same time, but can be executed at different times. These sub-steps or stages are not necessarily executed sequentially, but can be executed in turn or alternately with other steps or at least some of sub-steps or stages of other steps.

It is to be noted that the computer-readable medium in the present disclosure may be a computer-readable signal medium or a non-transitory computer-readable storage medium, or any combination of a computer-readable signal medium and a computer-readable storage medium. The computer-readable storage medium may include, but is not limited to, an electronic, magnetic, optical, electromagnetic, infrared, or semiconductor system, apparatus, or device, or any combination of the foregoing. More specific instance of the non-transitory computer-readable storage medium may include, but is not limited to, an electrical connection based on one or more wires, a portable computer diskette, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the non-transitory computer-readable storage medium may be any tangible medium that includes or stores a program for use by or in conjunction with an instruction execution system, apparatus, or device. In the present disclosure, the compute-readable signal medium may include a data signal propagating in a baseband or as part of a carrier wave and carrying a computer-readable program code. Such a propagated data signal may have a variety of forms and may include, but is not limited to, an electromagnetic signal, an optical signal, or any suitable combination of the foregoing. The computer-readable signal medium may also be any computer-readable medium besides a computer-readable storage medium. The computer-readable signal medium can transmit, propagate, or transfer a program for use by or in conjunction with an instruction execution system, apparatus, or device. A program code included on a computer-readable medium may be transferred by means of any suitable medium, including, but not limited to, wires, fiber optic cables, radio frequency (RF), etc., or any suitable combination of the foregoing.

The computer-readable medium may be included in the above electronic device, and may also exist independently without being installed into the electronic device.

The above computer-readable medium carries one or more programs. When executed by the electronic device, the one or more programs cause the electronic device to execute the method shown in the embodiments.

According to an aspect of the present disclosure, a computer program product or a computer program is further provided. The computer program product or the computer program includes a computer instruction. The computer instruction is stored in a computer-readable storage medium. A processor of a computer device reads the computer instruction from the computer-readable storage medium. The processor executes the computer instruction to cause the computer device to execute the methods of the implementations described in the disclosure.

A computer program code for performing operations of the present disclosure may be written in one or more programming languages, or combinations of the programming languages. The programming languages include target-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case of involving a remote computer, the remote computer may be connected with a user computer through any kind of network, including a local area network (LAN) or a wide area network (WAN), or may be connected with an external computer (for example, connected through the Internet by using an Internet service provider).

The flowcharts and block diagrams in the accompanying drawings illustrate the architecture, functionality, and operations possibly implemented by the systems, methods, and computer program products according to various embodiments of the present disclosure. In this regard, each block in the flowcharts or block diagrams may represent a module, a program segment, or part of a code, and a module, a program segment, or part of a code includes one or more executable instructions for implementing a specified logical function. It is also to be noted that in some alternative implementations, a function noted in a block may occur in an order different from an order noted in the figures. For example, two blocks represented in succession can in fact be executed substantially in parallel or in a reverse order sometimes, depending on the functions involved. It is also to be noted that each block in the block diagrams and/or the flowcharts and combinations of blocks in the block diagrams and/or the flowcharts can be implemented through special-purpose hardware-based systems that execute the specified functions or operations, or can be implemented through combinations of special-purpose hardware and computer instructions.

The modules described in the embodiment of the present disclosure may be implemented in software or hardware. The name of a module in a case does not constitute a qualification of the module itself, for example, a module A can also be described as “a module A for executing operation B”.

The above description is merely illustrative of embodiments of the present disclosure and principles of the technology employed. It is to be understood by those skilled in the art that the disclosed scope involved in the present disclosure is not limited to the technical solutions in which the described technical features are specifically combined, but encompasses other technical solutions in which the described technical features or equivalent features are arbitrarily combined without departing from the concept of the present disclosure, for example, technical solutions formed by interchanging the features described with (non-limitative) technical features disclosed in the present disclosure that have similar functions.

1. A sensing measurement setup method, performed by a sensing initiator, comprising:
receiving a sensing measurement setup termination request frame, and obtaining a first sensing measurement setup identifier (MSID) comprised in the sensing measurement setup termination request frame; and
setting up, in a case that the first MSID corresponds to at least two sensing responders, sensing measurement with a first responder in the sensing responders;
wherein the sensing responders comprise the first responder and a second responder, and the second responder is a sensing responder that transmits the sensing measurement setup termination request frame.

2. The sensing measurement setup method according to claim 1, wherein in a case that the first MSID corresponds to at least two sensing responders, the method further comprises:
transmitting a sensing measurement setup termination message frame to the second responder, and terminating a sensing measurement setup process of the second responder.

3. The sensing measurement setup method according to claim 1, wherein setting up the sensing measurement with the first responder in the sensing responders comprises:
transmitting a sensing measurement setup request frame to the first responder, wherein a sensing measurement parameter comprised in the sensing measurement setup request frame is identical to a sensing measurement parameter of a sensing measurement process corresponding to the first MSID.

4. The sensing measurement setup method according to claim 1, wherein setting up the sensing measurement with the first responder in the sensing responders comprises:
configuring for the first responder an MSID identical to the first MSID.

5. The sensing measurement setup method according to claim 1, wherein setting up the sensing measurement with the first responder in the sensing responders comprises:
determining that a sensing measurement report parameter of a sensing measurement process corresponding to the first MSID is supported by the first responder, setting up the sensing measurement with the first responder in the sensing responders.

6. The sensing measurement setup method according to claim 1, wherein setting up the sensing measurement with the first responder in the sensing responders comprises:
determining that the first responder is unassociated with the sensing initiator, and assigning a user identifier (UID) to the first responder.

7. The sensing measurement setup method according to claim 1, wherein after obtaining the first MSID comprised in the sensing measurement setup termination request frame, the method further comprises:
transmitting a sensing measurement setup termination message frame to the sensing responders and terminating a sensing measurement setup process of the sensing responders, in a case that the first MSID corresponds to one sensing responder.

8. A sensing measurement setup method, performed by a sensing responder, wherein the sensing responder is a first responder, and the method comprises:
receiving a sensing measurement setup request frame transmitted by a sensing initiator, wherein the sensing measurement setup request frame is transmitted by the sensing initiator in a case that the sensing initiator receives a sensing measurement setup termination request frame transmitted by a second responder and determines that a first sensing measurement setup identifier (MSID) comprised in the sensing measurement setup termination request frame corresponds to at least two sensing responders; and the sensing responders comprise the first responder and the second responder; and
setting up sensing measurement with the sensing initiator in response to the sensing measurement setup request frame.

9-10. (canceled)

11. An electronic device, applied to a sensing initiator, comprising:
a memory that stores a computer program; and,
one or more processors communicatively coupled to the memory;
wherein, the computer program, when collectively executed by the one or more processors, causes the electronic device to:
receive a sensing measurement setup termination request frame, and obtain a first sensing measurement setup identifier (MSID) comprised in the sensing measurement setup termination request frame; and
set up, in a case that the first MSID corresponds to at least two sensing responders, sensing measurement with a first responder in the sensing responders;
wherein the sensing responders comprise the first responder and a second responder, and the second responder is a sensing responder that transmits the sensing measurement setup termination request frame.

12. A non-transitory computer-readable storage medium, storing a computer program, wherein the computer program when executed by a processor of the sensing initiator, causes the sensing initiator to perform the method according to of claim 1.

13. The electronic device according to claim 11, wherein in a case that the first MSID corresponds to at least two sensing responders, the electronic device is further configured to:
transmit a sensing measurement setup termination message frame to the second responder, and terminate a sensing measurement setup process of the second responder.

14. The electronic device according to claim 11, wherein the electronic device is further configured to:
transmit a sensing measurement setup request frame to the first responder, wherein a sensing measurement parameter comprised in the sensing measurement setup request frame is identical to a sensing measurement parameter of a sensing measurement process corresponding to the first MSID.

15. The electronic device according to claim 11, wherein the electronic device is further configured to:
configure for the first responder an MSID identical to the first MSID.

16. The electronic device according to claim 11, wherein the electronic device is further configured to:
determine that a sensing measurement report parameter of a sensing measurement process corresponding to the first MSID is supported by the first responder, and set up the sensing measurement with the first responder in the sensing responders.

17. The electronic device according to claim 11, wherein the electronic device is further configured to:
determine that the first responder is unassociated with the sensing initiator, assign a user identifier (UID) to the first responder.

18. The electronic device according to claim 11, wherein the electronic device is further configured to: after obtaining the first MSID comprised in the sensing measurement setup termination request frame,
transmit a sensing measurement setup termination message frame to the sensing responders and terminate a sensing measurement setup process of the sensing responders, in a case that the first MSID corresponds to one sensing responder.

19. An electronic device, comprising:
a memory that stores a computer program; and
one or more processors communicatively coupled to the memory;
wherein the computer program when collectively executed by the one or more processors causes the electronic device to act as the sensing responder and perform the method according to claim 8.

20. A non-transitory computer-readable storage medium, storing a computer program, wherein the computer program when executed by a processor of the sensing responder, causes the sensing responder to perform the method according to claim 8.
